(19) United States
(12) Patent Application Publication
(10) Pub. No.: US 2026/0371309 A1
(43) Pub. Date: Nov. 19, 2026

(54) METHOD FOR CONSTRUCTING CHANNEL FINGERPRINT TWIN AND SYSTEM THEREOF

(71) Applicant: Southeast University, Nanjing (CN)

(72) Inventors: Li YOU, Nanjing (CN); Zhenzhou JIN, Nanjing (CN); Xudong LI, Nanjing (CN); Chenjie XIE, Nanjing (CN); Wenya FAN, Nanjing (CN); Junwei HU, Nanjing (CN); Zeye XU, Nanjing (CN); Xiqi GAO, Nanjing (CN)

(21) Appl. No.: 19/491,300

(22) PCT Filed: Jan. 16, 2025
(86) PCT No.: PCT/CN2025/072676

§ 371 Date: Dec. 8, 2025

(30) Foreign Application Priority Data
Jan. 6, 2025 (CN) 202510012614.X

(51) Int. Cl. H04W 64/00; G06T 3/4046; G06T 5/60; G06T 5/70; G06T 11/60; H04B 17/391

(52) U.S. Cl. CPC H04W 64/006; G06T 3/4046; G06T 5/60; G06T 5/70; G06T 11/60; H04B 17/3913; G06T 2207/20081; G06T 2207/20084; G06T 2210/32

(57) ABSTRACT

Coarse-grained channel fingerprint and fine-grained channel fingerprint are regarded as physical objects and digital twin objects by the present disclosure, and the relations between the physical objects and the digital twin objects are constructed by utilizing an image super-resolution technique. An evidence lower bound of fine-grained channel fingerprint twin likelihood is derived according to a variational inference and reparameterization theory to be taken as a target function, and the coarse-grained channel fingerprint is introduced to be taken as side information to design a conditional generation type diffusion model for generating the fine-grained channel fingerprint, and the conditional generation type diffusion model can be deployed in the core computing unit of channel fingerprint twin. In addition, a one-shot pruning algorithm and a multi-objective knowledge distillation technique are further introduced to obtain a lightweight conditional generative diffusion model.

### TECHNICAL FIELD

The present disclosure belongs to the technical field of communication technology, and relates to a method for constructing a channel fingerprint twin and a system thereof based on an image super-resolution method.

### BACKGROUND

With the dramatic increase in antenna array size in MIMO-OFDM (Multi-input Multi-output Orthogonal Frequency Division Multiplexing) communication systems, the sharp rise in the number and density of user equipment, and the utilization of wider bandwidth, 6G networks faces the challenge of handling ultra-large dimensional MIMO channels. Excessive overhead is caused by utilizing the traditional pilot-based channel training and feedback methods to obtain real-time channel state information (CSI). In addition, the stochastic modeling based on specific assumptions and probability distribution of the channel parameters is generally adopted by the traditional channel modeling methods, but these strict assumptions may be difficult to be guaranteed in the highly dynamic and complex wireless propagation environments. It is worth noting that the wireless propagation environment is a key factor affecting channel parameters and the performance of wireless communication systems. Therefore, wireless communication with environment awareness receives increasing attentions in academia and industry. Channel fingerprint (CF), also known as channel knowledge map or channel knowledge base, is an emerging environment-aware wireless communication technique that provides channel knowledge of specific locations related to potential base stations for an arbitrary base station to user equipment pair. Specifically, fine-grained CF is similar to a channel knowledge base containing all precise locations within the target communication area, marked with the precise locations of transmitters and receivers as well as the corresponding channel knowledge. This database stores channel-related knowledge at specific locations, such as channel gain, angle of arrival (AoA), and/or angle of departure (AoD), which is capable of addressing the challenges of real-time CSI acquisition and providing support for the design of wireless transmission technologies.

Obviously, finer-grained channel fingerprints help base stations obtain more accurate and location-specific channel information, are used to guide wireless transmission design to significantly improve communication gain. However, the degree of sophistication of the channel fingerprints obtained in the actual communication scenarios is limited by the number of sensor nodes actually deployed, as well as the limits of the measurement and storage costs, resulting in the fact that most of the acquired channel fingerprints are coarse-grained. In this case, the performance of the wireless communication system degrades since the error in obtaining channel information cannot be ignored. At present, most of the related work focuses on constructing channel fingerprints by utilizing the characteristics of the physical propagation environments or the prior assumptions of the physical propagation model, and few studies focus on reconstructing fine-grained channel fingerprints from actually measured coarse-grained channel fingerprints. Therefore, the present disclosure defines the mapping from coarse-grained channel fingerprints to fine-grained channel fingerprint twin as a channel fingerprint twin, and proposes a method for constructing channel fingerprint twin.

### SUMMARY

Invention objectives: In view of the disadvantages of the prior art, the present disclosure discloses a method for constructing a channel fingerprint twin (Channel Fingerprint Twin), which can reconstruct finer-grained channel information from coarse-grained channel information collected from the sensor and/or channel test side, thereby implementing more accurate environmental perception-enabled wireless communication.

Technical solutions: In order to construct fine-grained channel fingerprints, the present disclosure proposes a channel fingerprint twin construction solution with the conditional generative diffusion model (CGDM) as the core computing unit, which is configured to efficiently construct the connections between coarse-grained channel fingerprints and fine-grained channel fingerprints, and following technical solutions are provided by the present disclosure.

In the first aspect, provided by the present disclosure is a method for constructing a channel fingerprint twin, and the method includes the following steps.

Channel knowledge at a part of locations within an interested area is acquired, and the acquired channel knowledge into a coarse-grained channel fingerprint with an image structure is rearranged through a spatial discretization method and a grayscale conversion method, and then a mapping task from the coarse-grained channel fingerprint to a fine-grained channel fingerprint twin is transformed into an image super-resolution problem.

A conditional generative diffusion model (CGDM) is constructed, the CGDM is trained by giving a training set containing paired coarse-grained fingerprints and fine-grained channel fingerprints, and optimal parameters for the CGDM are solved.

A finally trained CGDM is taken as a core computing unit of a channel fingerprint twin, and the corresponding fine-grained channel fingerprint twin is reconstructed by utilizing the coarse-grained channel fingerprint as side information, and channel knowledge of user equipment at potential locations within the interested area is predicted.

Preferably, the spatial discretization and the grayscale conversion is to grid a wireless propagation environment map in a spatial dimension, and to use a minimum to maximum normalization to convert the channel knowledge into an interval ranging from 0 to 1, facilitating subsequent neural network processing.

Preferably, an objective function of training the CGDM is a negative log-likelihood of a target data distribution conditioned on the side information, and an evidence lower bound of the objective function is derived by utilizing a variational inference and a reparameterization technique, and the evidence lower bound is taken as a loss function of the proposed CGDM for training and the loss function is expressed as:

$$\underline{ℒ} ( θ ) := {\sum }_{t = 1}^{T} {𝔼}_{{G}_{0} , {ε}_{t}} ( {‖ {ε}_{t} - {ε}_{θ} ( G , {\underbrace{\sqrt{{\overline{α}}_{t}} {G}_{0} + \sqrt{1 - {\overline{α}}_{t} ε}}}_{{G}_{t}} , t ) ‖}_{2}^{2} ) ,$$

where T denotes the number of time steps of noise diffusion, [symbol] _{G}_{₀}_{,ε}_{₁}(·) denotes an expectation operation, εₜ denotes a noise at the t-th step, ε_{θ}(·,·,·) denotes a denoising neural network, θ denotes model parameters,

$${\overline{α}}_{t} = {\prod }_{i = 1}^{t} {α}_{i} , {α}_{t} = 1 - {β}_{t} , {β}_{t}$$

denotes a variance of the noise added at the t-th step, ε~ [symbol] (0,I) denotes a Gaussian noise with a mean vector of 0 and a covariance matrix of an identity matrix I, G₀ denotes the fine-grained channel fingerprint input to the CGDM, G denotes the coarse-grained channel fingerprint as the side information input to the model, Gₜ denotes an intermediate latent variable of the fine-grained channel fingerprint between t=1 and t=T, and ∥·∥₂ denotes a L2 norm.

Preferably, the method for constructing the channel fingerprint twin further includes following steps.

Redundant CGDM parameters are removed by adopting a one-shot pruning approach, and a lightweight conditional generative diffusion model (LiCGDM) is obtained.

Pruned LiCGDM parameters are fine-tuned by adopting a multi-objective knowledge distillation technique, to solve problems of model performance degradation caused by the one-shot pruning approach.

A finally trained LiCGDM is taken as a core computing unit of the channel fingerprint twin.

Preferably, in the step of obtaining a lightweight conditional generative diffusion model (LiCGDM) by adopting a one-shot pruning approach, and the pruning objective function is specifically expressed as:

$${min}_{{p}_{1} , {p}_{2} , … , {p}_{\tilde{m}}} {\sum }_{1}^{\tilde{m}} 𝔼 {‖ {ε}_{t e a} - ε ( {p}_{i} ) ‖}_{2}^{2} ,$$

$$s . t . \{ {p}_{1} , {p}_{2} , … , {p}_{\tilde{m}} \} ⊂ {\tilde{L}}^{\tilde{n}} , {\sum }_{i = 1}^{\tilde{m}} Params ( {p}_{i} ) \geq 𝒫 ,$$

where εₜₑₐ denotes an output of the CGDM before pruning, {p₁, p₂, . . . , p_{\tilde{m}}} denotes different network layers, \tilde{L}^{ñ} denotes a set of all prunable network layers, Params (pᵢ) denotes the number of parameters of a pᵢ-th layer, P denotes the number of parameters to be pruned, ε(pᵢ) denotes an output of the model after pruning the pᵢ-th layer, and \tilde{m} denotes uncertain variables.

Preferably, weights of the pruned LiCGDM is further readjusted by adopting the multi-objective knowledge distillation technique, to implement performance recovery, and a task objective and two knowledge distillation objectives are specifically combined as a loss function to implement overall retraining of the model, and the loss function is expressed as:

$${ℒ}_{KD} = {ℒ}_{Task} + {λ}_{O} {ℒ}_{OKD} + {λ}_{F} {ℒ}_{FKD} ,$$

$${ℒ}_{Task} = {𝔼}_{\dot{G} , {G}_{t} , {ε}_{t}} {‖ {ε}_{t} - {ε}_{S} ( \dot{G} , {G}_{t} , t ) ‖}_{2}^{2} ,$$

$${ℒ}_{OKD} = {𝔼}_{\dot{G} , {G}_{t} , t} {‖ {ε}_{T} ( \dot{G} , {G}_{t} , t ) - {ε}_{S} ( \dot{G} , {G}_{t} , t ) ‖}_{2}^{2} ,$$

$${ℒ}_{FKD} = {\sum }_{i} {𝔼}_{\dot{G} , {G}_{t} , t} {‖ {F}_{T}^{i} ( \dot{G} , {G}_{t} , t ) - {F}_{S}^{i} ( \dot{G} , {G}_{t} , t ) ‖}_{2}^{2} ,$$

where εₜ denotes a noise of the t-th step, ε_{S}(·) and ε_{T}(·) denote an output of a denoising neural network in LiCGDM and an output of a denoising neural network in CGDM, respectively,

$${ℱ}_{T}^{i} ( \dot{G} , {G}_{t} , t ) and {ℱ}_{S}^{i} ( \dot{G} , {G}_{t} , t )$$

denotes a feature map output by an i-th network layer of CGDM and a feature map output by an i-th network layer of LiCGDM, respectively, and λ_{O} and λ_{F} denote distillation loss value weights, respectively.

Preferably, a denoising neural network framework of the CGDM is implemented based on the U-Net framework, and the denoising neural network framework of the CGDM is mainly composed of three stages: a downsampling layer, an intermediate layer and an upsampling layer, and main modules of the denoising neural network framework of the CGDM include a time embedding module based on a sine and cosine position encoding, a residual module and a self-attention module.

Preferably, the three stages of the downsampling layer, the intermediate layer and the upsampling layer in the CGDM include a plurality of integrated residual and self-attention modules; X, Γₜ are defined as a feature map corresponding to the channel fingerprint and a time embedding vector corresponding to a time constant t, respectively, and an output X′ of the residual module is expressed as:

$${X}^{′} = \{ \begin{matrix}Ω + {f}_{Conv , 1} ( X ) , if {c}_{out} \neq {c}_{in} \\ Ω + X , else\end{matrix} ,$$

where Ω=g (g(X)+f_{Ful}(f_{Swi} (f_{Ful}(Γₜ)))) denotes an intermediate quantity in a feature extraction process, g(X)=f_{Conv,3} (f_{Dro} (f_{Swi} (f_{Gn} (X)))), f_{Conv,3}(·) and f_{Conv,1} (·) denote 3×3 and 1×1 convolution operations, respectively, f_{Ful} (·) and f_{Swi} (·) denote a linear layer and an activation function layer, respectively, f_{Dro}(·) and f_{Gn}(·) denote a dropout layer function and a group normalization layer function, respectively, cᵢₙ and cₒᵤₜ denote the number of input and output feature map channels, respectively.

In the second aspect, provided by the present disclosure is a wireless communication channel fingerprint twin system, and the system includes a coarse-grained channel fingerprint acquisition module and a channel fingerprint twin module.

The coarse-grained channel fingerprint acquisition module is configured to acquire channel knowledge at a part of locations within an interested area, and rearrange the acquired channel knowledge into a coarse-grained channel fingerprint with an image structure through a spatial discretization method and a grayscale conversion method, and then transform a mapping task from the coarse-grained channel fingerprint to a fine-grained channel fingerprint twin into an image super-resolution problem.

The channel fingerprint twin module is configured to reconstruct a fine-grained channel fingerprint twin in a target area through a trained conditional generative diffusion model CGDM or a lightweight conditional generative diffusion model LiCGDM lightweighted by an one-shot pruning approach and a multi-objective knowledge distillation method; the CGDM is trained based on a training set containing paired coarse-grained channel fingerprint and fine-grained channel fingerprint to obtain model optimal parameters; and take the trained CGDM or the LiCGDM as a core computing unit of a channel fingerprint twin, and reconstruct a corresponding fine-grained channel fingerprint twin by utilizing the coarse-grained channel fingerprint as side information, and predict channel knowledge of user equipment at potential locations within the interested area.

In the third aspect, provided by the present disclosure is a computer program product, comprising a computer program or instruction, when the computer program or instruction is executed by a processor, steps of a method for constructing a channel fingerprint twin are implemented

Beneficial effects: In comparison with the prior art, in the present disclosure, the mapping task from the coarse-grained channel fingerprint to the fine-grained channel fingerprint twin is transformed into an image super-resolution problem, a conditional generative diffusion model is designed, the coarse-grained channel fingerprint is taken as the side information, the directions of iterative denoising of the model are guided, and then the fine-grained channel fingerprint twin is constructed. In order to reduce the model calculation amount and memory usage, a one-shot pruning and multi-objective knowledge distillation method are further introduced by the present disclosure, which can accurately obtain the channel information of user equipment in ultra-high precision position in the target area with low computational complexity and storage complexity while ensuring the reconstruction accuracy. The obtained fine-grained channel fingerprint can further assist in the acquisition of real-time channel state information for the large-scale wireless communication, and can be used to guide wireless transmission design, thereby greatly improving the overall transmission efficiency of the system. In addition, the method proposed by the present disclosure is equipped with a stronger generalization ability and is suitable for channel fingerprint reconstruction under different fine-grained requirements.

### BRIEF DESCRIPTION OF THE DRAWINGS

FIG. 1 illustrates a flow chart of constructing a channel fingerprint twin according to an embodiment of the present disclosure.

FIG. 2 illustrates a flow chart of constructing a channel fingerprint twin according to another embodiment of the present disclosure.

FIG. 3 illustrates a schematic diagram of a deployment method of a base station antenna in an embodiment of the present disclosure.

FIG. 4 illustrates a framework diagram of a model adopted in a channel fingerprint twin core computing unit in an embodiment of the present disclosure.

FIG. 5 illustrates a flow chart of an algorithm for solving a one-shot pruning problem in an embodiment of the present disclosure;

FIG. 6 illustrates a schematic diagram showing the impacts of the number of basic channels of the input feature map in the latent space on the performance effect of the instance in an embodiment of the present disclosure.

### DETAILED DESCRIPTION OF THE EMBODIMENTS

In order to enable those skilled in the art to better understand the solutions of the present disclosure, the technical solution in the embodiments of the present disclosure will be clearly and completely described below in conjunction with the drawings in the embodiments of the present disclosure. Obviously, the described embodiments are merely parts of the embodiments of the present disclosure, not all of the embodiments. Based on the embodiments of the present disclosure, all other embodiments obtained by ordinary technicians in this field without any creative work should fall within the protection scope of of the present disclosure.

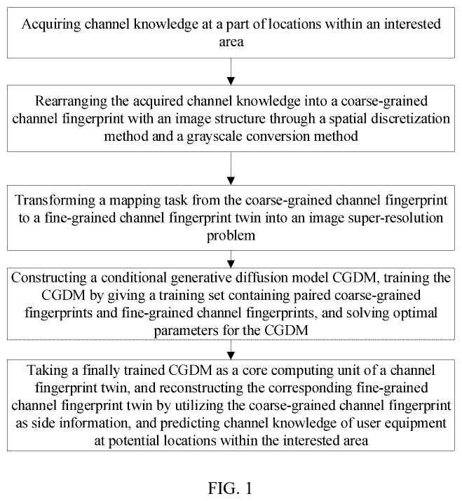

As illustrated in FIG. 1, the embodiments of the present disclosure disclose a method for constructing a channel fingerprint twin, and the method includes the following steps. First, channel knowledge at a part of locations within an interested area is acquired, and the acquired channel knowledge into a coarse-grained channel fingerprint with a image structure is rearranged through a spatial discretization method and a grayscale conversion method, and then a mapping task from the coarse-grained channel fingerprint to a fine-grained channel fingerprint twin is transformed into an image super-resolution problem. And then a conditional generative diffusion model CGDM is constructed, the CGDM is trained by giving a training set containing paired coarse-grained fingerprints and fine-grained channel fingerprints, and optimal parameters for the CGDM are solved. Finally, a finally trained CGDM is taken as a core computing unit of a channel fingerprint twin, and the corresponding fine-grained channel fingerprint twin is reconstructed by utilizing the coarse-grained channel fingerprint as side information, and channel knowledge of user equipment at potential locations within the interested area is predicted.

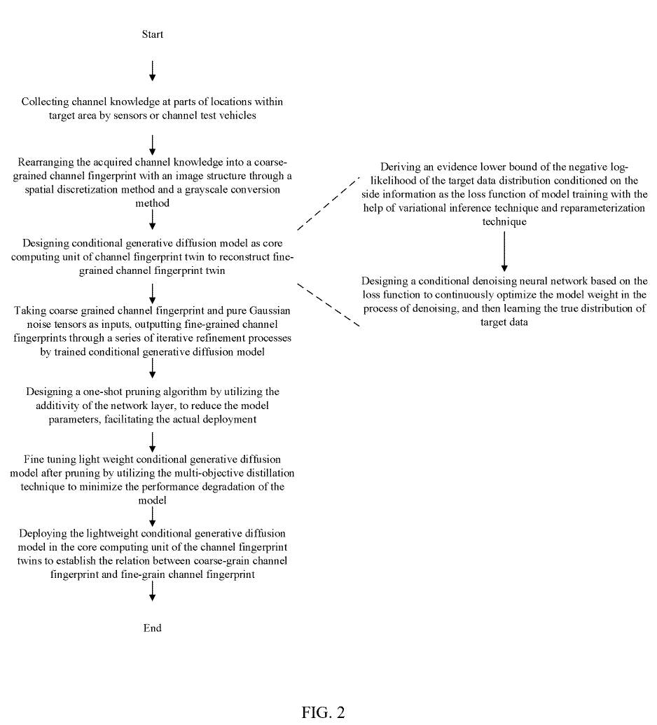

The embodiments of the present disclosure convert the mapping task of coarse-grained channel fingerprint (regarded as a physical object) to fine-grained channel fingerprint (regarded as a digital twin object) into an image super-resolution problem, designs a conditional generative diffusion model, introduces the coarse-grained channel fingerprint as side information, and guides the model to perform directional iterative fine-grained channel fingerprint construction. In the more preferred embodiments, in order to reduce the model calculation amount and memory usage, a one-shot pruning and multi-objective knowledge distillation method is introduced to reduce the consumption of computing and storage resources. As illustrated in FIG. 2, the specific steps include: (1) actually deployed sensors or channel test vehicles are provided to collect channel knowledge at parts of locations within the target area. (2) the channel knowledge measured in the target area is rearranged into a coarse-grained channel fingerprint with a 2D image structure through spatial discretization and grayscale conversion, and then the mapping task from coarse-grained channel fingerprint to fine-grained channel fingerprint twin is converted into an image super-resolution problem. (3) a conditional generative diffusion model CGDM with a Markov chain structure is constructed, a training set containing paired coarse-grained and fine-grained channel fingerprints is given, and the CGDM is trained, and the optimal parameters for the model are solved. Specifically, in Step (3), a variational inference and a reparameterization technique are utilized to derive the evidence lower bound of the negative log-likelihood of the target data distribution conditioned on the side information as the loss function of model training, and the loss function is expressed as:

$$\underline{ℒ} ( θ ) := {\sum }_{t = 1}^{T} {𝔼}_{{G}_{0} , {ℰ}_{t}} ( {‖ {ε}_{t} - {ε}_{θ} ( \dot{G} , {\underbrace{\sqrt{{\overline{α}}_{t}} {G}_{0} + \sqrt{1 - {\overline{α}}_{t}} ε}}_{{G}_{t}} , t ) ‖}_{2}^{2} ) .$$

In order to reduce a large amount of memory consumption and delay, a one-shot pruning approach is adopted to remove redundant model parameters to obtain a lightweight model LiCGDM, which is convenient for the actual deployment of the model. And multi-objective knowledge distillation technique is further introduced to fine-tune the parameters for the pruned lightweight model obtained from the above training to solve the problem of model performance degradation caused by one-shot pruning. In this embodiment, the data set is divided into a training set (5000), a validation set (1000) and a test set (1000) in a ratio of 5:1:1. The Adam optimization algorithm and unsupervised training method are adopted to train the above model. The batch size set during the training process is 16, and the learning rate is set to 0.00005. This training strategy is used for more than 500000 iterations, and the exponential moving average algorithm is introduced at the 5000th iteration. The decay factor is set to 0.9999. In addition, a dropout strategy with a dropout rate set to 0.1 is adopted in the model. During the training process, the weight parameters for the model are adjusted utilizing the validation set, and the final performance of the model is tested utilizing the test set. (4) The above trained model or the pruned lightweight model is used as the core computing unit of the channel fingerprint twin, and is used for the efficient construction of fine-grained channel fingerprint twin in the target area in the field of wireless communication.

The specific steps of the embodiments of the present disclosure are described below in conjunction with specific scenarios.

### 1. System Model

A massive multiple-input multiple-output orthogonal frequency division multiplexing (MIMO-OFDM) communication scenario is considered in a square communication area A⊂ [symbol] where the location of the user equipment is defined as

$${\{ {x}_{m} \}}_{m = 1}^{M} = 𝒜 .$$

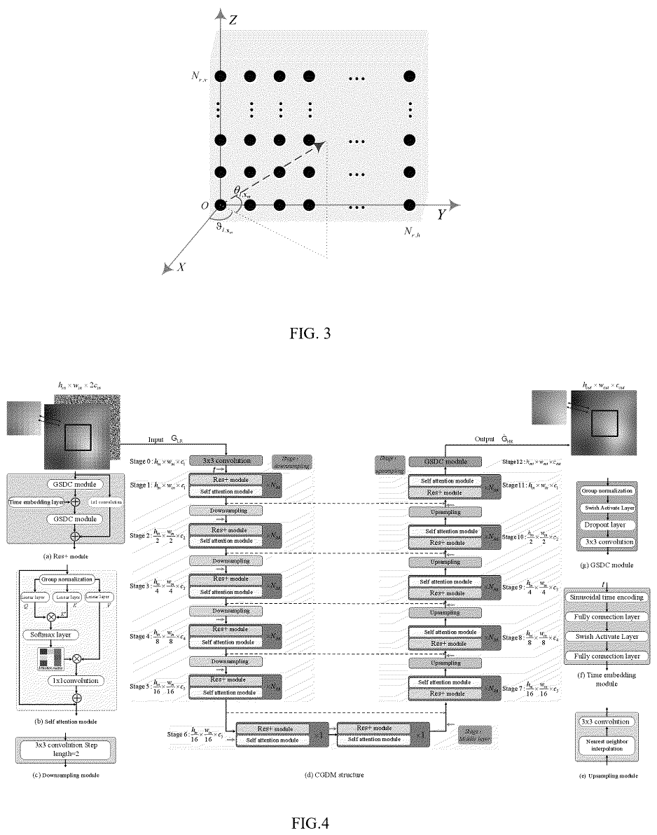

As illustrated in FIG. 3, the base station (BS) is equipped with a uniform linear array (ULA) composed of Nᵣ+=N_{r,v}×N_{r,h} antenna elements, which are arranged at half-wavelength intervals to serve M single-antenna users in the cell, where N_{r,v} and N_{r,h} denote the number of antennas in the vertical column and horizontal row, respectively. It is assumed that in the considered wireless propagation environment, Lₓ_{ₘ} physical propagation paths exist from the BS to the user equipment located at xₘ. OFDM modulation with No subcarriers is adopted in the system, and the spacing between subcarriers is Δ_{f}. Typically, N_{c} active subcarriers are selected in the center of N_{c} subcarriers for signal transmission, and the remaining subcarriers are used as guard bands, and the active subcarrier set is defined as

$$𝒦 = \{ - \frac{{N}_{k}}{2} , - \frac{{N}_{k}}{2} + 1 , … , \frac{{N}_{k}}{2} - 1 \} .$$

The spatial-frequency domain channel response between the base station and the user equipment on the active subcarrier [symbol] is modeled as:

$${h}^{H} ( {x}_{m} ) = {\sum }_{l - 1}^{{L}_{{x}_{m}}} {α}_{l , {x}_{m}} {a}_{t}^{H} ( {τ}_{l , {x}_{m}} ) ⊗ {a}_{h}^{H} ( {ψ}_{l , {x}_{m}} ) ⊗ {a}_{V}^{H} ( {ϕ}_{l , {x}_{m}} ) , \qquad ( 1 )$$

where α_{l,x}_{ₘ} and aₜ(τ_{l,x}_{ₘ}) denote the complex gain and propagation delay of the I-th path corresponding to the user equipment located at xₘ, respectively, and ⊗ denotes the Kronecker product. The normalized horizontal angle ψ_{l,x}_{ₘ}∈[−1,1] is related to the elevation angle θ_{l,x}_{ₘ}, and the normalized vertical angle φ_{l,x}_{ₘ}∈[−1,1] corresponds to the elevation angle

$${θ}_{l , {x}_{m}} ∈ [ - \frac{π}{2} , \frac{π}{2} ]$$

through the relation φ_{l,x}_{ₘ}=sin θ_{l,x}_{ₘ}. The azimuth angle

$${ϑ}_{l , {x}_{m}} ∈ [ - \frac{π}{2} , \frac{π}{2} ]$$

is defined as ψ_{l,x}_{ₘ}=cos θ_{1,x}_{ₘ} sin θ_{l,x}_{ₘ}. The steering vectors aₜ(τ_{l,x}_{ₘ}) aₜ(τ_{l,x}_{ₘ}) and aᵥ(,φ_{l,x}_{ₘ}) are expressed as:

$${a}_{v} ( {ϕ}_{l , {x}_{m}} ) = {[ 1 , {e}^{- π {ϕ}_{l , {x}_{m}}} , … , {e}^{- π ( {N}_{r , v} - 1 ) {ϕ}_{l , {x}_{m}}} ]}^{T} , \qquad ( 2 )$$

$${a}_{h} ( {ψ}_{l . {x}_{m}} ) = {[ 1 , {e}^{- π {ψ}_{l , {x}_{m}}} , … , {e}^{- π ( {N}_{r , h} - 1 ) {ψ}_{l , {x}_{m}}} ]}^{T} , \qquad ( 3 )$$

$${a}_{t} ( {τ}_{l , {x}_{m}} ) = {[ {e}^{- 2 π ( - \frac{{N}_{k}}{2} ) {Δ}_{f} {τ}_{l , {x}_{m}}} , … , {e}^{- 2 π ( \frac{{N}_{k}}{2} - 1 ) {Δ}_{f} {τ}_{l , {x}_{m}}} ]}^{T} , \qquad ( 4 )$$

where aₕ(ψ_{l,x}_{ₘ})∈ [symbol] ^{N}^{_{r,h}}^{×1}, aₜ(φ_{1,x}_{ₘ})∈ [symbol] ^{N}^{_{v,h}}^{×1} and aₜ(τ_{l,x}_{ₘ})∈ [symbol] ^{N}^{ₖ}^{×1}. The base band signal received at the terminal are commonly described as:

y(xₘ)=h^{H}(xₘ)s+z(xₘ), (5)

where s denotes the transmitted signal symbol of power P_{X}, and z(xₘ) denotes the additive noise of the single-sided power spectral density N₀.

The channel in Formula (1) typically contains large-scale fading (path loss and shadowing) and small-scale fading, the former of which typically varies over distances in meters, while the latter fluctuates over distances in the order of wavelengths. Considering that the massive MIMO-OFDM systems operate at wavelengths in the millimeter or centimeter scale, it is estimated that small-scale fading component would require to know the location of the terminal with millimeter-level accuracy, which is impractical for current technologies, such as global navigation satellite systems. Therefore, it is generally assumed that the effects of small-scale fading are averaged out, which is quite realistic in scenarios where channel measurements are made while the test vehicle is moving.

### 2. Channel Gain Model

The channel gain attenuation observed at the terminal may be dominated by various environmental factors, such as propagation losses from different paths, reflections and diffractions from buildings. Therefore, among these effects, the relatively slowly varying parts contribute to the channel gain function, which is then expressed as \tilde{G}(e, xₘ), and the channel gain function \tilde{G}(e,xₘ) denotes the large-scale signal attenuation measured at the user location

$${\{ {x}_{m} \}}_{m = 1}^{M} = 𝒜 ,$$

where e denotes the propagation environment. In addition, the small-, scale effect is generally modeled as a complex Gaussian random variable \tilde{h} with unit variance. Therefore, the received base band signal in Formula (5) can be expressed in a more general form as:

$$y ( 𝔢 , {x}_{m} ) = \sqrt{\tilde{G} ( 𝔢 , {x}_{m} )} \tilde{h} s + \tilde{z} ( 𝔢 , {x}_{m} ) , \qquad ( 6 )$$

where the average received energy of each symbol can be expressed as:

$${P}_{Y} = \frac{{𝔼 [ \vert y ( 𝔢 , {x}_{m} ) \vert}^{2} ]}{B} = \frac{\tilde{G} ( 𝔢 , {x}_{m} ) {P}_{X}}{B} + {N}_{0} , \qquad ( 7 )$$

where B denotes the signal bandwidth. The channel gain of the user equipment located at xₘ, in dB, is defined as:

G(e,xₘ)=(P_{Y})_{dB}−(P_{X})_{dB}, (8)

which reflects the change in the received power of the user equipment located at xₘ in the propagation environment e. Then, the set of channel gains at potential locations is called a channel fingerprint (CF). It is worth noting that when the channel gain at an arbitrary location in the interested area can be accurately obtained, a fine-grained CF can be constructed in the embodiments of the present disclosure, which is particularly important for transceiver design in large-scale MIMO systems. It should be noted that in this embodiment, channel gain is taken as an example of channel fingerprint. It can be understood that the channel fingerprint can be other channel knowledge such as path loss and channel delay.

### 3. Problem Statement

Since the considered communication area is a square area A⊂ [symbol] , in the embodiments of the present disclosure, the spatial discretization is performed along the X-axis and the Y-axis. Specifically, considering that the size of the interested area is [symbol] × [symbol] , a resolution factor σ is defined, so that the minimum spacing unit in the spatial discretization process is Δₓ= [symbol] /σ and Δ_{y}= [symbol] /σ, each spatial grid is defined as Λ_{i,j}, where i=1, 2, . . . , [symbol] /Δₓ, j=1, 2, . . . , [symbol] /Δ_{y}, the (i, j)-th spatial grid is expressed as:

Λ_{i,j}=[iΔₓ,jΔ_{y}]^{T}. (9)

A resolution factor σ is given, the CF corresponding to the potential user equipment location within the target geometric area can be rearranged into a two-dimensional tensor and recorded as:

[G]_{i,j}=G(e,Λ_{i,j}). (10)

It should be noted that when the target area size is [symbol] × [symbol] and the resolution factor is σ, the number of points that is required to be interpolated is [symbol] /σ². As the resolution factor σ increases, the complexity of the traditional interpolation algorithm increases by O(( [symbol] /σ)³) which raises a significant challenge to construct fine-grained CF in practical scenarios. On the other hand, the increase in the density of test nodes can improve the spatial resolution of CF, which can be implemented by significantly increasing the number of sensor nodes or utilizing test vehicles to collect channel knowledge at smaller geographical intervals. However, both methods may not be impractical due to high hardware and labor costs. A coarse-grained factor σ_{LR} and a fine-grained factor σ_{HR} are defined, σ_{HR} is generally a power of 2 of σ_{LR}, such as 2×, 4×, 8×. In view of CF with resolution factor σ_{LR}, it is defined as G_{LR}, the target area A⊂ [symbol] is discretized into a 2D tensor with the size of σ_{LR}×σ_{LR}, and G_{HR} is defined in a similar way. The task of CF twin focuses on reconstructing fine-grained CF G_{HR} from a given coarse-grained CF G_{LR}, especially in scenarios constrained by measurement cost, privacy, or security.

In a typical image super-resolution (ISR) task in the field of computer vision, the objective is to reconstruct a high-resolution (HR) image from a given low-resolution (LR) corresponding image to enhance the details and overall quality of the image. It can be seen that the task in the embodiments of the present disclosure is consistent with the ISR task, thus the fine-grained CF reconstruction problem is analyzed from the perspective of ISR in the embodiments of the present disclosure. Specifically, in the embodiments of the present disclosure, the elements of the G_{LR} matrix are regarded as pixels, the coarse-grained CF G_{LR} is regarded as an LR image, and the fine-grained CF G_{HR} is regarded as an HR image. Then, the objective is to learn a specific mapping relation to effectively reconstruct the HR CF G_{HR} from the given LR CF G_{LR}, and is expressed as:

[symbol]

_{Θ}:G_{LR,u}→G_{HR,u},∀UE{1,2, . . . ,U}, (11)

where Θ denotes the parameters set of the mapping [symbol] _{Θ}, and U denotes the number of training samples. However, a classic and challenging inverse problem involving the efficient reconstruction of fine details from a given LR CF is raised in this task. Considering that the conditional distribution of the HR CF output given a LR CF input does not commonly follow a simple parametric distribution, most ISR regression methods based on feedforward neural networks generally perform poorly at high magnification factors and cannot accurately recover details. Success is achieved by the deep generative models in learning the complex empirical distribution of target data. Specifically, when implicit prior information of the HR CF distribution can be learned, such as the gradient of the logarithmic density of the data, it can be converted to the target CF distribution through iterative sampling steps from the criterion normal distribution, similar to Langevin dynamics. Therefore, the mapping relation in Formula (11) can be solved by optimizing the following objective:

$$arg min {𝔼}_{{P}_{data} ( G )} [ {‖ ∇ log {P}_{data} ( G ) - ∇ log {P}_{Θ} ( G ) ‖}_{2}^{2} ] , \qquad ( 12 )$$

$$s . t . {x}_{m} ∈ 𝒜 , u ∈ \{ 1 , 2 , … , U \}$$

where ∇ log P_{data}(G) denotes the gradient of the logarithmic density of HR CF, also known as the Stein score, and P_{Θ} denotes the learned density. It should be noted that the noise learned by the traditional GDM is shown to be equivalent to the Stein score, which makes it possible to generate HR CF samples that are consistent with the target data distribution. In order to accurately reconstruct an HR CF from a given LR CF, and the task is pathological, which means that the reconstruction process may produce a plurality of possible solutions for the HR CF. In other words, different HR CFs may be mapped to the same LR CF. Therefore, unlike the traditional GDM, which starts with a pure Gaussian noise tensor, it is crucial to introduce additional source signals as side information (also as a guiding condition), to achieve the optimal solution. To this end, the learned prior information is combined and the LR CFGLR is introduced as an additional source signal to guide the iterative optimization process by the method of the embodiment of the present disclosure.

### 4. Method for Constructing CGDM Based Fine-Grained Channel Fingerprint Twin

### 1. Overall Design of CGDM

To simplify the notation, G_{LR} and G_{HR} are denoted by Ġ and Ġ, respectively. a paired LR CF input and HR CF output dataset are given, and

$${𝒟 = ( {\dot{G}}_{u} , {G}_{u} \}}_{u = 1}^{U}$$

is defined to denotes samples drawn from an unknown distribution p(Ġ,G). These datasets are generally collected from sensor nodes and test vehicles, and are equipped with different resolution factors depending on the specific scenario, such as, σ_{LR} and σ_{HR}. In the task of the embodiments of the present disclosure, the focus is on learning the parameter approximation of
P(G|G) through a directed iterative refinement process guided by source information, which makes the mapping of G to G possible. In view of the powerful implicit prior learning ability of GDM, a CGDM is designed to facilitate the generation of G in the embodiments of the present disclosure.

Specifically, CGDM generates a target HR CF defined as G₀ over T refinement time steps, and starts with G_{T}~N(0,I) included by the pure Gaussian noise, and iteratively refines this initial input according to the source signal and the prior information learned during training, that is, the conditional distribution p_{θ}(Gₜ₋₁|Gₜ, Ġ), where 0 and I denote the mean vector as 0 and the covariance matrix as the identity matrix, respectively. As each time step t evolves, a sequence of outputs CF defined as {G_{T-1}, G_{T-2}, . . . , G₀} are produced, and finally the target HR CF G₀~p(G|Ġ) are obtained. Specifically, the distribution of intermediate CF in the iterative refinement chain is controlled by a forward diffusion process that gradually adds noise to the output CF through a fixed Markov chain, defined as q(Gₜ|Gₜ₋₁). The model of the embodiments of the present disclosure attempts to iteratively recover the signal from the noise through a reverse Markov chain conditioned on the source CF G, thereby reversing the Gaussian diffusion process. In order to implement this point, the embodiments of the present disclosure learns the reverse chain by optimizing the denoising neural network ε_{θ}(·) utilizing the following objective function Formula (35), and the LR CF and the noisy image is taken as input to estimate the noise by the trained CGDM, and after T refinement time steps, the target HR CF is generated.

2. Forward Diffusion Process Starting from HR CF

HR CF samples drawn from a distribution of interest are considered, and defined as G₀~q(G). GDM is trained by adopting a fixed diffusion process q(G_{1:T}|G₀) involving relatively high-dimensional latent variables. This process defines a forward diffusion mechanism, a deterministic Markov chain where Gaussian noise is gradually introduced into the samples over T time steps. The noise level at each step is determined by the variance table

$${\{ {β}_{t} ∈ ( 0 , 1 ) \}}_{t = 1}^{T} .$$

Specifically, the forward diffusion process is defined as:

$$q ( {G}_{1 : T} \vert {G}_{0} ) = {\prod }_{t = 1}^{T} q ( {G}_{t} \vert {G}_{t - 1} ) . \qquad ( 13 )$$

It should be noted that the forward diffusion subprocess, also called as the encoder, does not require to be learned at each time step t. Instead, it is a fixed and predefined linear Gaussian model that can be expressed as

$$q ( {G}_{t} \vert {G}_{t - 1} ) = 𝒩 ( {G}_{t} ; \sqrt{1 - {β}_{t}} {G}_{t - 1} , {β}_{t} I ) , \qquad ( 14 )$$

$${G}_{t} = \sqrt{1 - {β}_{t}} {G}_{t - 1} + \sqrt{{β}_{t}} ε , \qquad ( 15 )$$

where ε denotes Gaussian noise, and the distribution is [symbol] (ε;0,I), and αₜ=1−βₜ and

$${\overline{α}}_{t} = {\prod }_{i = 1}^{t} {α}_{i} ,$$

are defined.

Under the linear Gaussian assumption of the transfer density q(Gₜ|Gₜ₋₁), in combination with Formulas (14) and (15), the reparameterization technique can be utilized by the embodiments of the present disclosure to sample Gₜ in a closed form at an arbitrary given time step t:

$${G}_{t} = \sqrt{{\overline{α}}_{t}} {G}_{0} + \sqrt{1 - {\overline{α}}_{t}} ε , \qquad ( 16 )$$

$$q ( {G}_{t} \vert {G}_{0} ) = 𝒩 ( {G}_{t} , \sqrt{{\overline{α}}_{t}} {G}_{0} , ( 1 - {\overline{α}}_{t} ) I ) . \qquad ( 17 )$$

where the variance change is generally set as β₁<β₂< . . . <β_{T}. When β_{T} is infinitely close to 1, for an arbitrary initial state G₀, G_{T} converges to a criterion Gaussian distribution, that is, q(G_{T}|G₀)≈ [symbol] (G_{T}; 0,I).
3. Reverse process conditioned on LR CF

For traditional GDM, the reverse process can be regarded as a decoding process. At each time step t, Gₜ is denoised and restored to G_{t,1}, and the transition probability of each step is expressed as p(Gₜ₋₁|Gₜ). Based on the Markov density transition property, the joint distribution of the reverse process is expressed as:

$$p ( {G}_{0 : T} ) = p ( {G}_{T} ) {\prod }_{t = 1}^{T} p ( {G}_{t - 1} \vert {G}_{t} ) . \qquad ( 18 )$$

However, the expression for p(Gₜ₋₁|Gₜ) derived by utilizing Bayes' theorem reveals that the denominator contains an integral, thus lacking a closed-form solution. Therefore, it is necessary to approximate these conditional probabilities utilizing a denoising neural network with parameter θ to perform the reverse process. Since the reverse process is a Markov chain, the reverse process can be expressed as:

$$p ( {G}_{0 : T} ) = p ( {G}_{T} ) {\prod }_{t = 1}^{T} {p}_{θ} ( {G}_{t - 1} \vert {G}_{t} ) , \qquad ( 19 )$$

$${p}_{θ} ( {G}_{t - 1} \vert {G}_{t} ) = 𝒩 ( {G}_{t - 1} ; {μ}_{θ} ( {G}_{t} , t ) , {\sum }_{θ} ( {G}_{t} , t ) ) . \qquad ( 20 )$$

In the task of the embodiments of the present disclosure, unlike the traditional GDM, the denoising model ε_{θ}(·) is conditioned on the side information in the form of LR CF, guiding the side information to gradually denoise from the Gaussian distribution Gr and generate HR CF G₀. Therefore, Formulas (19) and (20) require to be rewritten as:

$$p ( {G}_{0 : T} \vert \dot{G} ) = p ( {G}_{T} ) {\prod }_{t = 1}^{T} {p}_{θ} ( {G}_{t - 1} \vert {G}_{t} , \dot{G} ) , \qquad ( 21 )$$

$${p}_{θ} ( {G}_{t - 1} \vert {G}_{t} , \dot{G} ) = 𝒩 ( {G}_{t - 1} , {μ}_{θ} ( \dot{G} , {G}_{t} , t ) , {\sum }_{θ} ( \dot{G} , {G}_{t} , t ) ) . \qquad ( 22 )$$

### 4. CGDM Optimization Based on Evidence Lower Bound

In order to enable the network model ε_{θ}(·) to effectively approximate the inverse process, the model parameters θ require to be optimized with specific objectives. Mathematically, the latent variables Gr and the observed samples G₀ conditioned on Ġ, can be expressed by the conditional joint distribution p(G_{0:T}|Ġ). In generative modeling, a common likelihood-based method optimizes the model by maximizing the conditional joint probability distribution p(G_{0:T}|Ġ) of all observed samples. However, the embodiments of the present disclosure can merely access the observed samples G₀, but not the latent variables G_{1:T}. Therefore, the embodiments of the present disclosure requires to maximize the conditional marginal distribution p(G₀|Ġ), that is,

p(G₀|Ġ)=∫pp(G_{0:T}|Ġ)dG_{1:T}. (23)

In the framework of variational inference, the likelihood of the observed sample G₀ conditioned on Ġ, that is, evidence, enables the embodiments of the present disclosure to derive the evidence lower bound (ELBO) as a proxy objective function for optimizing CGDM:

$$log p ( {G}_{0} \vert \dot{G} ) = log \int p ( {G}_{0 : T} \vert \dot{G} ) {dG}_{1 : T} {⩾}^{( a )} {𝔼}_{q ( {G}_{1 : T \vert {G}_{0}} )} ( log \frac{p ( {G}_{0 : T} \dot{G} )}{q ( {G}_{1 : T} \vert {G}_{0} )} ) , \qquad ( 24 )$$

where [symbol] comes from Jensen's inequality. In order to further derive ELBO, Formula (24) can be rewritten as:

$$log p ( {G}_{0} \vert \dot{G} ) ⩾ {𝔼}_{q ( {G}_{1 : T} \vert {G}_{0} )} ( log \frac{p ( {G}_{T} ) {p}_{θ} ( {G}_{0} \vert {G}_{1} , \dot{G} )}{q ( {G}_{1} \vert {G}_{0} )} + log \frac{q ( {G}_{1} \vert {G}_{0} )}{q ( {G}_{T} \vert {G}_{0} )} + log {\prod }_{t = 2}^{T} \frac{{p}_{θ} ( {G}_{t - 1} \vert {G}_{t} , \dot{G} )}{q ( {G}_{t - 1} \vert {G}_{t} , {G}_{0} )} ) = {\underbrace{{𝔼}_{q ( {G}_{1} \vert {G}_{0} )} ( log {p}_{θ} ( {G}_{0} \vert {G}_{1} , \dot{G} ) )}}_{{ℒ}_{a}} - {\underbrace{{\sum }_{t = 2}^{T} {𝔼}_{q ( {G}_{t} \vert {G}_{0} )} ( {D}_{KL} ( q ( {G}_{t - 1} \vert {G}_{t} , {G}_{0} ‖ {p}_{θ} ( {G}_{t - 1} \vert {G}_{t} , \dot{G} ) ) )}}_{{ℒ}_{b}} - {\underbrace{{D}_{KL} ( q ( {G}_{T} \vert {G}_{0} ‖ p ( {G}_{T} ) )}}_{{ℒ}_{t}} = {ℒ}_{ELBO} ( θ ) , \qquad ( 25 )$$

where D_{KL}(·) denotes the KL divergence (KL, Kullback-Leibler). Then, the parameters θ for CGDM can be learned by optimizing the negative ELBO:

$${arg min}_{θ} ℒ ( θ ) = 𝔼 ( - {ℒ}_{ELBO} ( θ ) ) = 𝔼 ( {ℒ}_{c} + {ℒ}_{b} - {ℒ}_{a} ) , \qquad ( 26 )$$

where [symbol] (θ) denotes the objective function for training CGDM.

In view of [symbol] (θ), in the embodiments of the present disclosure, it is noted that [symbol] _{c} is a constant and can be excluded from the optimization, while [symbol] ₐ can be approximated and optimized by Monte Carlo estimate. From the above analysis, it can be seen that the training objective of CGDM is mainly determined by [symbol] _{b}. It can be found that the training objective of CGDM is to approximate the transfer density in the reverse process as closely as possible, so as to minimize the KL divergence between p₇₄ (Gₜ₋₁|Gₜ,Ġ)= [symbol] (Gₜ₋₁;μ_{θ}(Ġ,Gₜ,t),Σ_{θ}(Ġ,Gₜ,t) and q(Gₜ₋₁|Gₜ,G₀)= [symbol] (Gₜ₋₁;\tilde{μ}ₜ(Gₜ,G₀),\tilde{β}ₜI). Therefore, the embodiment of the present disclosure requires to obtain explicit expressions of the mean [symbol] (Gₜ,G₀) and variance [symbol] of q(Gₜ₋₁|Gₜ,G₀). Specifically, q(Gₜ₋₁|Gₜ,G₀) can be expressed as

$$q ( {G}_{t - 1} \vert {G}_{t} , {G}_{0} ) = \frac{q ( {G}_{t} \vert {G}_{t - 1} , {G}_{0} ) q ( {G}_{t - 1} \vert {G}_{0} )}{q ( {G}_{t} \vert {G}_{0} )} . \qquad ( 27 )$$

Combining Formulas (16) and (17), (27) can be further rewritten as:

$$q ( {G}_{t - 1} \vert {G}_{t} , {G}_{0} ) = exp ( - \frac{1}{2} ( \frac{\frac{1}{( 1 - {α}_{t} ) ( 1 - {\overline{α}}_{t - 1} )}}{1 - {\overline{α}}_{t}} ) ( {G}_{t - 1}^{2} - 2 \frac{\sqrt{{α}_{t}} ( 1 - {\overline{α}}_{t - 1} ) {G}_{t} + \sqrt{{\overline{α}}_{t - 1}} ( 1 - {α}_{t} ) {G}_{0}}{1 - {\overline{α}}_{t}} {G}_{t - 1} ) ) . \qquad ( 28 )$$

Based on (28), the mean and variance of q(Gₜ₋₁|Gₜ,G₀) can be explicitly expressed as:

$${\tilde{μ}}_{t} ( {G}_{t} , {G}_{0} ) = \frac{1}{\sqrt{{α}_{t}}} ( {G}_{t} - \frac{{β}_{t}}{\sqrt{1 - \overline{{α}_{t}}}} {ε}_{t} ) , \qquad ( 29 )$$

$${\tilde{β}}_{t} = \frac{1 - {\overline{α}}_{t - 1}}{1 - {\overline{α}}_{t}} {β}_{t} . \qquad ( 30 )$$

Typically, the variance τ_{θ}(Ġ,Gₜ,t) is set to a constant [symbol] Therefore, in order to ensure that the denoising transition density closely approximate the ground-truth denoising transition density, the embodiment of the present disclosure can simplify the optimization of the KL divergence term, thereby minimizing the difference between the means of the two distributions. In this case, the embodiment of the present disclosure merely requires to train the CGDM to predict [symbol] (Gₜ,G₀),

$${μ}_{θ} ( \dot{G} , {G}_{t} , t ) = \frac{1}{\sqrt{{α}_{t}}} ( {G}_{t} - \frac{1 - {α}_{t}}{\sqrt{1 - {\overline{α}}_{t}}} {ε}_{θ} ( \dot{G} , {G}_{t} , t ) ) , \qquad ( 31 )$$

$${G}_{t - 1} ∼ 𝒩 ( {G}_{t - 1} ; \frac{1}{\sqrt{{α}_{t}}} ( {G}_{t} - \frac{1 - {α}_{t}}{\sqrt{1 - \overline{{α}_{t}}}} {ε}_{θ} ( \dot{G} , {G}_{t} , t ) ) , {\tilde{β}}_{t} I ) . \qquad ( 32 )$$

The KL divergence is defined as:

$${D}_{K L} ( 𝒩 ( x ; {μ}_{K} , {\sum }_{K} ) ‖ 𝒩 ( y ; {μ}_{y} , {\sum }_{y} ) ) = \frac{1}{2} [ log \frac{\vert {\sum }_{y} \vert}{\vert {\sum }_{x} \vert} - d + tr ( {\sum }_{y}^{- 1} {\sum }_{x} ) + {( {μ}_{y} - {μ}_{x} )}^{T} {\sum }_{y}^{- 1} ( {μ}_{y} - {μ}_{x} ) ] , \qquad ( 33 )$$

where d denotes the dimension of x. Formulas (29), (31) and (33) are substituted into [symbol] _{b} in Formula (25) to obtain:

$${ℒ}_{b} = {\sum }_{t = 2}^{T} {𝔼}_{q ( {G}_{i} \vert {G}_{0} )} ( \frac{{( 1 - {α}_{t} )}^{2}}{2 {\tilde{β}}_{t}^{2} {α}_{t} ( 1 - {\overline{α}}_{t} )} {‖ {ε}_{t} - {ε}_{θ} ( \dot{G} , {G}_{t} , t ) ‖}_{2}^{2} ) . \qquad ( 34 )$$

Formulas (25) and (34) are substituted into Formula (26), the objective function [symbol] (θ) of CGDM can be further simplified as:

$$\underline{ℒ} ( θ ) := {\sum }_{t = 1}^{T} {𝔼}_{{G}_{0} , {ε}_{t}} ( {‖ {ε}_{t} - {ε}_{θ} ( \dot{G} , {\underbrace{\sqrt{{\overline{α}}_{t}} {G}_{0} + \sqrt{1 - {\overline{α}}_{t}} ε}}_{{G}_{t}} , t ) ‖}_{2}^{2} ) . \qquad ( 35 )$$

Based on the trained CGDM, given an arbitrary noise-contaminated image Gₜ, the trained CGDM can utilize the side information Ġ to predict the noise εₜ, and then obtain the approximate value for the target image Ĝ₀, through the conversion Formula (16), that is:

$${\hat{G}}_{0} = \frac{1}{\sqrt{{\overline{α}}_{t}}} ( {G}_{t} - \sqrt{1 - {\overline{α}}_{t}} {ε}_{θ} ( \dot{G} , {\underbrace{\sqrt{\overline{{α}_{t}}} {G}_{0} + \sqrt{1 - {\overline{α}}_{t}} ε}}_{{G}_{t}} , t ) ) . \qquad ( 36 )$$

By reparameterization, Formula (36) denotes the result of iterative refinement, and each iterative step in the CGDM proposed in the embodiments of the present disclosure is given by the following formula:

$${G}_{t - 1} ← \frac{1}{\sqrt{{α}_{t}}} ( {G}_{t} - \frac{1 - {α}_{t}}{\sqrt{1 - {\overline{α}}_{t}}} {ε}_{θ} ( \dot{G} , {G}_{t} , t ) ) + \sqrt{\frac{1 - {\overline{α}}_{t - 1}}{1 - {\overline{α}}_{t}} {β}_{t}} {ε}^{*} , \qquad ( 37 )$$

where ε*~ [symbol] (0,I), the noise estimation step in Formula (37) is similar to the Langevin dynamics step in score-based generative models, which is equivalent to estimating the first-order derivative of the log-likelihood of the observed sample, also known as the gradient or Stein score.

### 5. Network Architecture of CGDM

The backbone network used by the conditional denoising neural network in CGDM is a variant of the Unet network, which composed by three main stages: downsampling layer (Down), middle layer (Mid) and upsampling layer (Up). The key components of each stage include time embedding block, Res+ block, self-attention block, downsampling block and upsampling block. The architecture of the model is as illustrated in FIG. 4, and the specific module contents will be introduced one by one.

1) In order to encode the time parameters [1, . . . ,t, . . . , T] in the diffusion process, a time embedding encoding method based on sinusoidal position encoding is utilized, and the obtained time embedding Γₜ effectively captures the temporal features. It is defined that rᵢ^{j} ∈ [symbol] denotes the j-th component of the time embedding vector corresponding to time t:

$${Γ}_{t}^{( j )} = \{ \begin{matrix}cos ( \frac{t}{{10000}^{2 j / {c}_{time}}} ) , & if j is odd \\ sin ( \frac{t}{{10000}^{2 j / {c}_{time}}} ) , & if j is even\end{matrix} , \qquad ( 38 )$$

where j=0,1, 2, . . . , cₜᵢₘₑ/2-1, cₜᵢₘₑ denotes the dimension of the time embedding vector, and the embedding vector of the time constant t can be expressed as:

$${Γ}_{t} = [ sin ( {w}_{0} t ) , cos ( {w}_{0} t ) , sin ( {w}_{1} t ) , cos ( {w}_{1} t ) , … , sin ( {w}_{\frac{{c}_{time}}{2} - 1} t ) , cos ( {w}_{\frac{{c}_{time}}{2} - 1} t ) ] , \qquad ( 39 )$$

where

$${w}_{j} = 1 / 1000 {0}^{2 j / {c}_{time}} .$$

By utilizing Formula (39), the embedding vector at an arbitrary given time Γ_{t+Δt} can be obtained by the following linear transformation:

$${Γ}_{t + Δ t}^{T} = [ \begin{matrix}sin ( {w}_{0} ( t + Δ t ) ) \\ cos ( {w}_{0} ( t + Δ t ) ) \\ … \\ sin ( {w}_{\frac{{c}_{time}}{2} - 1} ( t + Δ t ) ) \\ cos ( {w}_{\frac{{c}_{time}}{2} - 1} ( t + Δ t ) )\end{matrix} ] = {M}_{Δ t} \cdot {Γ}_{t}^{T} , \qquad ( 40 )$$

where M_{Δt} denotes a linear transformation matrix, and is defined as:

$${M}_{Δ t} = [ \begin{matrix}R ( {w}_{0} Δ t ) & … & 0 \\ ⋮ & ⋱ & ⋮ \\ 0 & … & R ( {w}_{\frac{{c}_{time}}{2} - 1} Δ t )\end{matrix} ) , \qquad ( 41 )$$

where

$$R ( {w}_{0} Δ t ) = [ \begin{matrix}cos ( {w}_{0} Δ t ) & sin ( {w}_{0} Δ t ) \\ - sin ( {w}_{0} Δ t ) & cos ( {w}_{0} Δ t )\end{matrix} ] .$$

In order to enable the model to capture more complex temporal features, the temporal embedding is further enhanced by two fully connected layers and one activation layer, expressed as Γ′ₜ=f_{Ful} (f_{Swi} (f_{Ful} (Γₜ). f_{Ful}(·) and f_{Swi}(·) denote the fully connected layer and the swish activation function layer, respectively.

2) Res⁺ module: A deeper feature extraction network is designed to learn higher-level semantic information from CGM. Nevertheless, deep neural networks generally experience model degradation due to challenges such as gradient vanishing and exploding. To this end, residual connections are introduced as a way to alleviate these problems. Specifically, it is defined that X∈ [symbol] , and Γₜ is feature map and time embedding vector inputs, respectively, and the output of the Res⁺ module can be expressed as:

$${X}^{′} = \{ \begin{matrix}Ω + {f}_{Conv , 1} ( X ) , & if {c}_{out} \neq {c}_{in} \\ Ω + X , & else\end{matrix} , \qquad ( 42 )$$

where f_{Conv,1}(·) denotes a 1×1 convolution operation. Ω∈ [symbol] is defined as:

Ω=g(g(X)+f_{Ful}(f_{Swi}(f_{Ful}(Γₜ)))), (43)

where g(X)=f_{Conv,3}(f_{Dro} (f_{Swi} (f_{Gn} (X)))), f_{Conv,3}(·) denotes a 3×3 convolution operation. f_{Dro}(·) and f_{Gn}(·) denote the dropout layer and group normalization layer, respectively.

3) Self-attention module: In order to capture global structural information, a self-attention mechanism is introduced to improve the interaction between global and local features. Specifically, a normalized attention matrix is introduced to express different degrees of attention to the input, and greater weights are assigned to more important input components. The input is weighted according to the attention weights indicated in the attention matrix to generate the final output. Given the input

$$Z = {[ {z}_{1}^{T} , … , {z}_{m}^{T} ]}^{T} ∈ {ℝ}^{{d}_{m} \times {d}_{n}} ,$$

dₘ denotes the number of image blocks, dₙ denotes the feature dimension of each block, and three different linear transformations are performed on zⱼ:

kⱼ=zⱼW^{k},j=1, . . . ,dₙ, (44)

qⱼ=zⱼW^{q},j=1, . . . ,dₙ, (45)

vⱼ=zⱼW^{v},j=1, . . . ,dₙ, (46)

where kⱼ∈ [symbol] , qⱼ∈ [symbol] , and qⱼ∈ [symbol] denote the key, query and value vectors, respectively. W^{k}∈ [symbol] , W^{q}∈ [symbol] and W^{v}∈ [symbol] , denote the respective trainable transformation matrices. Specifically, the weight assignment function is determined by kⱼ and q_{j′}. A higher correlation q_{j′}k^{T}ⱼ means that the features of the j-th input block zⱼ have a higher importance for the j′-th output block. Typically, this correlation can be adaptively adjusted based on the input Z and matrices W^{k} and W^{q}. For clarity, the matrix forms of Formulas (44) to (46) are expressed as K=ZW^{k}, Q=ZW^{q}, V=ZW^{v}, where K=[k₁, . . . , kₘ]^{T} ∈ [symbol] , Q=[q₁, . . . , qₘ]^{T} ∈ [symbol] and V=[v₁, . . . , vₘ]^{T}∈ [symbol] , the attention matrix S_{AM} ∈ [symbol] is obtained by utilizing K and Q:

$${S}_{AM} = Softmax ( \frac{Q {K}^{T}}{\sqrt{η}} ) , \qquad ( 47 )$$

where Softmax(Z)=exp(zⱼ)/exp(zⱼ)/Σexp(zⱼ), \sqrt{η}>0 denotes a scaling factor. Finally, the output Z′ of the self-attention block can be expressed as:

$${Z}^{′} = {S}_{A M} [ : , : ] \cdot V = Softmax ( \frac{Z {W}^{q} {W}^{{k}^{T}} {Z}^{T}}{\sqrt{η}} ) Z {W}^{v} . \qquad ( 48 )$$

$$where O = {[ {o}_{l , … ,} {o}_{m} ]}^{T} ∈ {ℝ}^{{d}_{m} \times {d}_{n}} .$$

It should be noted that the three stages in the proposed conditional denoising neural network all contain N_{RA}≥2 Res⁺ and the corresponding self-attention modules, as illustrated in FIG. 4.

### V. LiCGDM Based on One-Shot Pruning and Multi-Objective Knowledge Distillation

### 1. Model Lightweighting Method Based on One-Shot Pruning

Considering that CGDM sacrifices a lot of memory consumption and latency to obtain excellent performance, the deployment on personal computers and even mobile equipment is highly restricted. To this end, in the embodiment of the present disclosure, a one-shot pruning approach is designed by utilizing the additivity of the network layer to obtain LiCGDM.

Given a specific pruning ratio, the objective of layer pruning is to remove a subset of prunable layers from the network structure of CGDM while minimizing the degradation of model performance. In the embodiment of the present disclosure, the mean square error (MSE) loss between the final output of the original network CGDM (called the “teacher”) and the final output of the pruned network LiCGDM (called the “student”) is minimized as the pruning objective. Specifically, the pruning objective function is expressed as:

$${min}_{{p}_{1} , {p}_{2} , … , {p}_{\tilde{m}}} 𝔼 {‖ {ε}_{t e a} - ε ( {p}_{1} , {p}_{2} , … , {p}_{\tilde{m}} ) ‖}_{2}^{2} \qquad ( 49 )$$

$$s . t . \{ {p}_{1} , {p}_{2} , … , {p}_{\tilde{m}} \} ⊂ {\tilde{L}}^{\tilde{n}} , {\sum }_{i = 1}^{m} ( {p}_{i} ) \geq 𝒫 ,$$

where εₜₑₐ denotes the output of the CGDM model before pruning, \tilde{L}^{ñ}={\tilde{l}₁, . . . , \tilde{l}_{ñ}} denotes the set of all network layers that can be pruned, pᵢ∈\tilde{L}^{ñ} denotes the i-th network layer that can be pruned, Params (pᵢ) denotes the number of parameters of the pᵢ-th layer, ε(p₁, p₂, . . . , p_{\tilde{m}}) denotes the network output after pruning the p₁, P₂, . . . , p_{\tilde{m}}-th layer, [symbol] denotes the number of parameters that is required to be pruned, ε(pᵢ) denotes the model output after pruning the pᵢ-th layer, and \tilde{m} denotes an uncertain variable. However, solving the above formula is an NP-hard problem, and the upper bound of the objective function requires to be obtained by utilizing the triangle inequality transformation:

$$𝔼 {‖ {ε}_{t e a} - ε ( {p}_{1} , {p}_{2} , … , {p}_{\tilde{m}} ) ‖}_{2}^{2} \leq {ℒ}_{upper} , \qquad ( 50 )$$

$$where$$

$${ℒ}_{upper} = 𝔼 {‖ {ε}_{t e a} - ε ( {p}_{1} ) ‖}_{2}^{2} + 𝔼 {‖ ε ( {p}_{1} ) - ε ( {p}_{1} , {p}_{2} ) ‖}_{2}^{2} + … + 𝔼 {‖ ε ( {p}_{1} , {p}_{2} , … , {p}_{\tilde{m} - 1} ) - ε ( {p}_{1} , {p}_{2} , … , {p}_{\tilde{m}} ) ‖}_{2}^{2} .$$

therefore, the optimization problem of Formula (49) is transformed into the problem of minimizing the upper bound:

$${min}_{{p}_{1} , {p}_{2} , … , {p}_{\tilde{m}}} {ℒ}_{upper} \qquad ( 51 )$$

$$s . t . \{ {p}_{1} , {p}_{2} , … , {p}_{\tilde{m}} \} ⊂ {\tilde{L}}^{\tilde{n}} , {\sum }_{i = 1}^{m} Params ( {p}_{i} ) \geq 𝒫 .$$

Although Formula (51) is still a NP-hard problem, by utilizing the additivity of the network layer, the output distortion caused by multiple perturbations can be approximated as the sum of the distortions caused by each individual perturbation, that is, the additivity can be expressed as:

$$𝔼 {‖ ε ( {p}_{1} , … , {p}_{i - 1} , {p}_{i} ) - ε ( {p}_{1} , … , {p}_{i - 1} ) ‖}_{2}^{2} \approx 𝔼 {‖ ε ( {p}_{1} , … , {p}_{2} , {p}_{i} ) - ε ( {p}_{1} , … , {p}_{i - 2} ) ‖}_{2}^{2} \approx … \approx 𝔼 {‖ ε ( {p}_{1} , {p}_{i} ) - ε ( {p}_{1} ) ‖}_{2}^{2} \approx 𝔼 {‖ ε ( {p}_{i} ) - {ε}_{t e a} ‖}_{2}^{2} . \qquad ( 52 )$$

Formula (52) is substituted into Formula (51), and a novel approximate proxy objective can be obtained:

$${min}_{{p}_{1} , {p}_{2} , … , {p}_{\tilde{m}}} {\sum }_{i = 1}^{\tilde{m}} 𝔼 {‖ {ε}_{t e a} - ε ( {p}_{i} ) ‖}_{2}^{2} \qquad ( 53 )$$

$$s . t . \{ {p}_{1} , {p}_{2} , … , {p}_{\tilde{m}} \} ⊂ {\tilde{L}}^{\tilde{n}} , {\sum }_{i = 1}^{m} Params ( {p}_{i} ) \geq 𝒫 .$$

It can be known from the above formula that the pruning criterion is completely determined by, so that

$$𝔼 {‖ {ε}_{t e a} - ε ( {\tilde{l}}_{i} ) ‖}_{2}^{2}$$

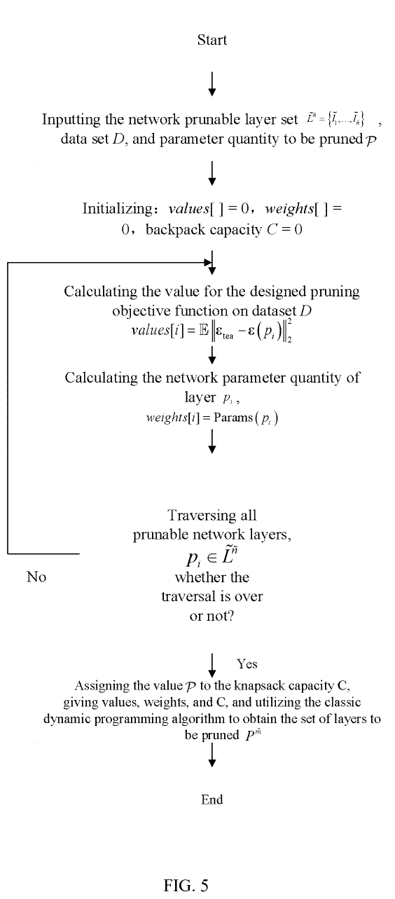

is merely acquired to be calculated for optimization solution. It is worth noting that the time complexity of calculating this objective function for each network layer is, so this problem can be converted into a 0-1 knapsack problem, and the classic dynamic programming algorithm can be utilized to solve the 0-1 knapsack problem. The specific algorithm flow is as illustrated in FIG. 5.

### 2. Method for Enhance Network Model Based on Multi-Objective Knowledge Distillation

Typically, deleting certain network layers from the teacher network will lead to a decrease in model performance. Therefore, in the embodiments of the present disclosure, a multi-objective knowledge distillation technique is adopted to further adjust the weights of the pruned model to implement performance recovery. A task objective and two knowledge distillation objectives are combined as a loss function to implement overall retraining of the model, and the loss function is expressed as:

$${ℒ}_{KD} = {ℒ}_{Task} + {λ}_{O} {t}_{OKD} + {λ}_{F} {L}_{FKD} , \qquad ( 54 )$$

$$where {ℒ}_{Task} = {𝔼}_{\dot{G} , {G}_{t} , {ε}_{t}} {‖ {ε}_{t} - {ε}_{S} ( \dot{G} , {G}_{t} , t ) ‖}_{2}^{2} ,$$

$${ℒ}_{OKD} = {𝔼}_{\dot{G} , {G}_{t} , {ε}_{t}} {‖ {ε}_{T} ( \dot{G} , {G}_{t} , t ) - {ε}_{S} ( \dot{G} , {G}_{t} , t ) ‖}_{2}^{2} ,$$

$${ℒ}_{FKD} = {\sum }_{i} {𝔼}_{\dot{G} , {G}_{t} , {ε}_{t}} {‖ {ℱ}_{T}^{i} ( \dot{G} , {G}_{t} , t ) - {ℱ}_{S}^{i} ( \dot{G} , {G}_{t} , t ) ‖}_{2}^{2} ,$$

ε_{S}(·) and ε_{T}(·) denote the outputs of the denoising neural network in LiCGDM and denoising neural network in CGDM, respectively,

$${ℱ}_{T}^{i} ( \dot{G} , {G}_{t} , t ) and {ℱ}_{S}^{i} ( \dot{G} , {G}_{t} , t )$$

denote the feature maps of the i-th network layer output of CGDM and LiCGDM, respectively, and λ_{O} and λ_{F} denote the distillation loss value weights, respectively. It is worth noting that by default, λ₀ and λ_{F} are set to 1 for training.

### VI. Implementation Effect

In order to enable those skilled in the art to better understand the solutions of the present disclosure, the following provides a comparison of the prediction performance results of the channel fingerprint prediction method in the embodiments of the present disclosure and the existing methods under several specific system configurations.

First, the system configuration of ultra-large-scale MIMO-OFDM is given as follows: the number of base station antennas is N_{r,v}×N_{r,h}=8×8, the target area size A=128 meters×128 meters, the center frequency is 2.4 GHz, the subcarrier spacing is 15 kHz, the base station height is set to 25 meters, and the user height is set to 1.5 meters. In the embodiments of the present disclosure, the QuaDRiGa generator (version 2.6.1) is adopted to simulate the real wireless communication system, and the 5G NR typical urban microcellular scenario “3GPP 38.901UMa NLOS” is considered as the specific communication scenario of the simulation experiment. Secondly, the hyperparameter configuration of the model is given as follows: N_{RA}=2, dropout probability dᵣ=0.1, learning rate α=0.00005, diffusion step number T=1000, β₁=10⁻⁴, β_{T}=0.01, Batch size is 16, the number of training iterations is 500000, the exponential moving average algorithm is introduced at the 5000-th iteration, the decay factor is set to 0.9999, the coarse-grained factor OLR and fine-grained factor σ_{HR} are 32 and 128, respectively.

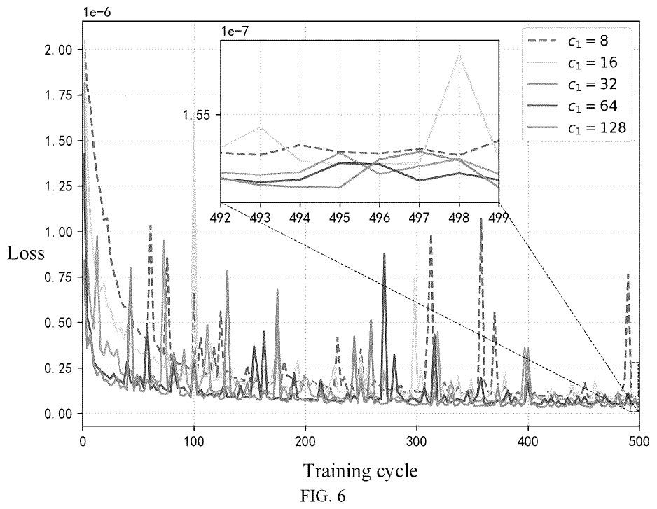

FIG. 6 illustrates the impacts of the number of basic channels of the input feature map in the latent space on the performance of the proposed model. It can be found that when the number of basic channels c₁ of the input feature map in the latent space increases from 8 channels to 128 channels, the proposed model implements better performance in terms of convergence speed and training stability. The analysis shows that this is because each feature channel can capture different types of information, the increase in feature channels can improve the expressiveness of the model and aggregate the underlying simple features and high-level abstract features, thereby improving the training efficiency of the model.

Table 1 Quantitative comparison of performance on fine-grained channel fingerprint twin reconstruction task

TABLE 1
Quantitative comparison of performance on fine-grained
channel fingerprint twin reconstruction task

| Reconstruction | | NMSE | | | |
|---|---|---|---|---|---|
| task | Method | (×10⁻⁵) | MSE | PSNR | SSIM |
| 32² →128² | SRGAN-MSE | 62.049 | 9.060 | 38.610 | 0.987 |
| | SRGAN | 69.942 | 10.220 | 38.104 | 0.987 |
| | C-VAE | 59.833 | 8.701 | 39.022 | 0.989 |
| | DRRN | 65.978 | 8.656 | 41.009 | 0.988 |
| | CGDM | 4.706 | 0.678 | 49.851 | 0.993 |
| | LiCGDM | 6.653 | 0.964 | 49.726 | 0.993 |

Table 1 shows a quantitative comparison of the reconstruction performance of CGDM and LiCGDM in the embodiments of the present disclosure with the existing methods. The compared methods are the SRGAN and SRGAN-MSE methods proposed in the literature: “Photo-realistic single image super-resolution using agenerative adversarial network,” in Proc. IEEE Conf. Comput. Vis. Pattern Recognit. (CVPR), July 2017, pp. 4681-4690, the C-VAE method in the literature “Auto-encoding variational Bayes,” in Proc. Int. Conf. Learn. Represent. (ICLR), Banff, AB, Canada, April 2014, pp. 1-14, and the DRRN method in the literature “Image super-resolution via deep recursive residual network,” in Proc. IEEE Conf. Comput. Vis. Pattern Recognit. (CVPR), July 2017, pp. 3147-3155. The performances of CGDM, LiCGDM in the embodiments of the present disclosure are compared with the performances of SRGAN-MSE, SRGAN, C-VAE and DRRN methods on the x4 super-resolution channel fingerprint dataset (32²→128²), and the performance indicators involved include normalized mean square error (NMSE), mean square error (MSE), peak signal-to-noise ratio (PSNR) and structure similarity index measure (SSIM). The model parameters involved in CGDM are set to: c₁=64, N_{RA}=2, c₁:c₂:c₃:c₄:c₅=1:2:4:8:16, and the pruning ratio adopted by LiCGDM is 35%. It can be found that in comparison with SRGAN, the NMSE and MSE of CGDM are reduced by 65.236×10⁻⁵ and 9.542, respectively, and the PSNR and SSIM are increased by 11.747 and 0.006, respectively, and the reconstruction accuracy is also significantly superior to the other comparison methods. In addition, in comparison with CGDM, LiCGDM has a slight decrease in performance indicators, but the decrease range is still within an acceptable range, which confirms that the proposed lightweight method effectively compresses CGDM to enable CGDM to be quickly deployed on personal computers and even mobile equipment.

Based on the same inventive concept, further provided is a wireless communication channel fingerprint twin system disclosed in an embodiment of the present disclosure. The system includes a coarse-grained channel fingerprint acquisition module and a channel fingerprint twin module.

The coarse-grained channel fingerprint acquisition module is configured to acquire channel knowledge at a part of locations within an interested area, and rearrange the acquired channel knowledge into a coarse-grained channel fingerprint with an image structure through a spatial discretization method and a grayscale conversion method, and then transform a mapping task from the coarse-grained channel fingerprint to a fine-grained channel fingerprint twin into an image super-resolution problem. And the channel fingerprint twin module is configured to reconstruct a fine-grained channel fingerprint twin in a target area through a trained conditional generative diffusion model CGDM or a lightweight conditional generative diffusion model LiCGDM lightweighted by an one-shot pruning approach and a multi-objective knowledge distillation method; the CGDM is trained based on a training set containing paired coarse-grained channel fingerprint and fine-grained channel fingerprint to obtain model optimal parameters; and take the trained CGDM or the LiCGDM as a core computing unit of a channel fingerprint twin, and reconstruct a corresponding fine-grained channel fingerprint twin by utilizing the coarse-grained channel fingerprint as side information, and predict channel knowledge of user equipment at potential locations within the interested area. The specific implementation details refer to the aforementioned embodiment, and are not repeated herein.

Based on the same inventive concept, further provided is a computer program product disclosed in the embodiments of the present disclosure. The computer program product includes a computer program or a instruction, which implements the steps of a method for constructing a channel fingerprint twin, when the computer program or the instruction are executed by a processor. The program or the instruction code for implementing the method of the present disclosure can be written in an arbitrary combination of one or more programming languages. These program or the instruction codes can be provided to a processor or controller of a general-purpose computer, a special-purpose computer, or other programmable data processing device, so that the program or the instruction code implements the steps of the method of the present disclosure when executed by a processor or controller. The program or the instruction code can be executed entirely on the machine, partially on the machine, partially on the machine as an independent software package and partially on a remote machine, or entirely on a remote machine or server. The contents are not described in detail in the present disclosure is a well-known technique for those skilled in the art.

In the embodiments provided in the present disclosure, it should be understood that the disclosed methods can be implemented in other ways without exceeding the spirit and scope of the present disclosure. The current embodiments are merely illustrative examples and should not be used as a limitation. The specific contents given should not limit the objectives of the present disclosure. For example, a plurality of features can be ignored or not executed.

The above is merely the specific embodiments of the present disclosure, but the protection scope of the present disclosure is not limited thereto. A person skilled in the art can easily conceive of changes or substitutions within the technical scope disclosed by the present disclosure, which should be included in the protection scope of the present disclosure. Therefore, the protection scope of the present disclosure should be based on the protection scope of the claims.

1. A method for constructing a channel fingerprint twin, wherein the method comprises following steps:
acquiring channel knowledge at a part of locations within an interested area, and rearranging, through a spatial discretization method and a grayscale conversion method, the acquired channel knowledge into a coarse-grained channel fingerprint with an image structure, and then transforming a mapping task from the coarse-grained channel fingerprint to a fine-grained channel fingerprint twin into an image super-resolution problem;
constructing a conditional generative diffusion model CGDM, training, by giving a training set containing paired coarse-grained fingerprints and fine-grained channel fingerprints, the CGDM, and solving optimal parameters for the CGDM; and
taking a finally trained CGDM as a core computing unit of a channel fingerprint twin, and reconstructing, by utilizing the coarse-grained channel fingerprint as side information, the corresponding fine-grained channel fingerprint twin, and predicting channel knowledge of user equipment at potential locations within the interested area.

2. The method for constructing the channel fingerprint twin according to claim 1, wherein the spatial discretization and the grayscale conversion is to grid a wireless propagation environment map in a spatial dimension, and to use a minimum to maximum normalization to convert the channel knowledge into an interval ranging from 0 to 1, facilitating a subsequent neural network processing.

3. The method for constructing the channel fingerprint twin according to claim 1, wherein an objective function of training the CGDM is a negative log-likelihood of a target data distribution conditioned on the side information, and deriving, by utilizing a variational inference and a reparameterization technique, an evidence lower bound of the objective function, and taking the evidence lower bound as a loss function of the proposed CGDM for training, and expressing the loss function as:
$$\underline{L} ( θ ) := {\sum }_{t = 1}^{T} {E}_{{G}_{0} , {ε}_{t}} ( {‖ {ε}_{t} - {ε}_{θ} ( \dot{G} , {\underbrace{\sqrt{\overline{{α}_{t}}} {G}_{{0}^{+}} \sqrt{1 - \overline{{α}_{t}}} ε}}_{{G}_{t}} , t ) ‖}_{2}^{2} ) ,$$
where T denotes a number of time steps of noise diffusion, E_{G}_{₀}_{,ε}_{₁}(·) denotes an expectation operation, εₜ at denotes a noise at a t-th step, ε₀(·,·,·) denotes a denoising neural network, θ denotes model parameters,
$${\text{?}}_{\text{?}} = {\prod }_{\text{?}}^{\text{?}} {\text{?}}_{\text{?}} , {\text{?}}_{\text{?}} = 1 - {β}_{\text{?}} , {β}_{\text{?}}$$
$$\text{?} \text{indicates text missing or illegible when filed}$$
denotes a variance of the noise added at the t-th step, ε□N(0,I) denotes a Gaussian noise with a mean vector of 0 and a covariance matrix of an identity matrix I, G₀ denotes the fine-grained channel fingerprint input to the CGDM, G denotes the coarse-grained channel fingerprint as the side information input to the model, Gₜ denotes an intermediate latent variable of the fine-grained channel fingerprint between t=1 and t=T, and ∥·∥₂ denotes a L2 norm.

4. The method for constructing the channel fingerprint twin according to claim 1, further comprising:
removing, by adopting a one-shot pruning approach, redundant CGDM parameters, and obtaining a lightweight conditional generative diffusion model LiCGDM;
fine-tuning, by adopting a multi-objective knowledge distillation technique, pruned LiCGDM parameters, to solve problems of model performance degradation caused by the one-shot pruning approach; and
taking a finally trained LiCGDM as a core computing unit of the channel fingerprint twin.

5. The method for constructing the channel fingerprint twin according to claim 4, wherein in the step of obtaining a lightweight conditional generative diffusion model LiCGDM by adopting a one-shot pruning approach, the pruning objective function is specifically expressed as:
$${min}_{{p}_{1} , {p}_{2} , … , {p}_{\tilde{m}}} {\sum }_{i = 1}^{\tilde{m}} E {‖ {ε}_{t e a} - ε ( {p}_{i} ) ‖}_{2}^{2} ,$$
$$s . t . \{ {p}_{1} , {p}_{2} , … , {p}_{\tilde{m}} \} ⊂ {\tilde{L}}^{\tilde{n}} , {\sum }_{i = 1}^{\tilde{m}} Params ( {p}_{i} ) \geq P ,$$
where εₜₑₐ denotes an output of the CGDM before pruning, {p₁, p₂, . . . , p_{m̅}} denotes different network layers, \tilde{L}^{ñ} denotes a set of all prunable network layers, Params (pᵢ) denotes a number of parameters of a pᵢ-th layer, P·denotes a number of parameters to be pruned, ε(pᵢ) denotes an output of the model after pruning the pᵢ-th layer, and \tilde{m} denotes uncertain variables.

6. The method for constructing the channel fingerprint twin according to claim 4, further comprising further readjusting, by adopting the multi-objective knowledge distillation technique, weights of the pruned LiCGDM, to implement performance recovery, and specifically combining a task objective and two knowledge distillation objectives as a loss function to implement an overall retraining of the model, and the loss function is expressed as:
$${L}_{KD} = {L}_{Task} + {λ}_{O} {L}_{OKD} + {λ}_{F} {L}_{FKD} ,$$
$${L}_{Task} = {E}_{\dot{G} , G , {ε}_{t}} {‖ {ε}_{t} - {ε}_{S} ( \dot{G} , {G}_{t} , t ) ‖}_{2}^{2} ,$$
$${L}_{O K D} = {E}_{\dot{G} , {G}_{i} , t} {‖ {ε}_{T} ( \dot{G} , {G}_{t} , t ) - {ε}_{S} ( \dot{G} , {G}_{t} , t ) ‖}_{2}^{2} ,$$
$${L}_{FKD} = {\sum }_{i} {E}_{\dot{G} , {G}_{i} , t} {‖ {F}_{T}^{i} ( \dot{G} , {G}_{t} , t ) - {F}_{S}^{i} ( \dot{G} , {G}_{t} , t ) ‖}_{2}^{2} ,$$
where εₜ denotes a noise of a t-th step, εs(·) and ε_{T}(·) denote an output of a denoising neural network in LiCGDM and an output of a denoising neural network in CGDM, respectively,
$${F}_{T}^{i} ( \dot{G} , {G}_{t} , t ) and {F}_{S}^{i} ( \dot{G} , {G}_{t} , t )$$
denotes a feature map output by an i-th network layer of CGDM and a feature map output by an i-th network layer of LiCGDM, respectively, and λ_{O} and λ_{F} denote distillation loss value weights, respectively.

7. The method for constructing the channel fingerprint twin according to claim 1, wherein a denoising neural network framework of the CGDM is implemented based on the U-Net framework, the denoising neural network framework of the CGDM is mainly composed of three stages of a downsampling layer, an intermediate layer and an upsampling layer, and main modules of the denoising neural network framework of the CGDM include a time embedding module based on a sine and cosine position encoding, a residual module and a self-attention module,

8. The method for constructing the channel fingerprint twin according to claim 1, wherein the three stages of the downsampling layer, the intermediate layer and the upsampling layer in the CGDM include a plurality of integrated residual module and self-attention modules;
X, Γₜ are defined as a feature map corresponding to the channel fingerprint and a time embedding vector corresponding to a time constant t, respectively, an output X⁻ of the residual module is expressed as:
$${X}^{′} = \{ \begin{matrix}Ω + {f}_{Conv , 1} ( X ) , & if {c}_{out} \neq {c}_{in} \\ Ω + X , & else\end{matrix} ,$$
where Ω=g(g(X)+f_{Ful}(f_{Swi}(f_{Ful}(Γₜ)))) denotes an intermediate quantity in a feature extraction process, g(X)=f_{Conv,3}(f_{Dro}(F_{Swi}(f_{Gn}(X)))), f_{Conv,3}(·) and f_{Conv,1}(·) denote 3×3 and 1×1 convolution operations, respectively, f_{Ful} (·) and f_{Swi}(·) denote a linear layer and an activation function layer, respectively, f_{Dro}(·) and f_{Gn}(·) denote a dropout layer function and a group normalization layer function, respectively, cᵢₙ and cₒᵤₜ denote a number of input and output feature map channels, respectively.

9. A wireless communication channel fingerprint twin system, wherein the system comprises:
a coarse-grained channel fingerprint acquisition module, configured to acquire channel knowledge at a part of locations within an interested area, and rearrange the acquired channel knowledge into a coarse-grained channel fingerprint with an image structure through a spatial discretization method and a grayscale conversion method, and then transform a mapping task from the coarse-grained channel fingerprint to a fine-grained channel fingerprint twin into an image super-resolution problem; and
a channel fingerprint twin module, configured to reconstruct a fine-grained channel fingerprint twin in a target area through a trained conditional generative diffusion model CGDM or a lightweight conditional generative diffusion model LiCGDM lightweighted by an one-shot pruning approach and a multi-objective knowledge distillation method; wherein the CGDM is trained based on a training set containing paired coarse-grained channel fingerprint and fine-grained channel fingerprint to obtain model optimal parameters; and take the trained CGDM or the LiCGDM as a core computing unit of a channel fingerprint twin, and reconstruct a corresponding fine-grained channel fingerprint twin by utilizing the coarse-grained channel fingerprint as side information, and predict channel knowledge of user equipment at potential locations within the interested area.

10. A computer program product, comprising a computer program and/or an instruction, wherein when the computer program or instruction is executed by a processor, steps of the method for constructing the channel fingerprint twin according to claim 1 are implemented.
